(19) United States
(12) Patent Application Publication
(10) Pub. No.: US 2025/0058813 A1
(43) Pub. Date: Feb. 20, 2025

(54) POWER ASSISTANCE DEVICE AND CONTROL METHOD THEREOF

(71) Applicant: WONDERLAND SWITZERLAND AG, Steinhausen (CH)

(72) Inventor: Tao WANG, Dongguan, Guangdong (CN)

(73) Assignee: WONDERLAND SWITZERLAND AG, Steinhausen (CH)

(21) Appl. No.: 18/721,066

(22) PCT Filed: Dec. 29, 2022
(86) PCT No.: PCT/EP2022/088003

§ 371 Date: Jun. 18, 2024

(30) Foreign Application Priority Data
Dec. 29, 2021 (CN) 202111638066.X

(51) Int. Cl. B62B 5/00; B62B 7/04; G06F 3/041

(52) U.S. Cl. CPC B62B 5/0073; B62B 7/04; G06F 3/041

(57) ABSTRACT

A power assistance device according to the present disclosure is used for providing power assistance to a carrier to be moved. The power assistance device includes: a pressure sensor for detecting a total weight of the carrier; a driving device for providing a driving force in a traveling direction to the carrier; a control unit being in signal connection with the pressure sensor and the driving device, receiving the total weight detected by the pressure sensor, and being capable of sending a signal to the driving device to adjust the driving force outputted by the driving device, such that when the total weight changes, an external force required to drive the carrier in the traveling direction is maintained at a constant preset force. A control method of the power assistance device is also disclosed.

### TECHNICAL FIELD

The present application relates to a power assistance device of a child stroller, and a control method for the power assistance device of the child stroller.

### BACKGROUND

A child stroller is a tool for taking care of a child. The physical burden of a caregiver can be reduced by using the child stroller, and the healthy development of the child may be improved accordingly.

Referring to FIGS. 1 to 3, a child stroller is shown in perspective views. As shown in FIGS. 1 to 3, the child stroller has a frame and a walking structure installed under the frame. The walking structure usually includes wheels, such as two front wheels and two rear wheels. A handle is installed above the frame. The caregiver can move the child stroller by holding the handle, thus providing a driving force for the child stroller. Obviously, when the child stroller carries different loads, and/or the child stroller is travelling uphill or downhill, the driving forces required to move the child stroller are different.

Currently, a child stroller which provide a power assistance function have been developed. For example, the power assistance is provided by a motor driving the wheel(s), so as to further reduce the physical burden of the caregivers. Most of conventional power-assisted child strollers are controlled via a control handle that is capable of detecting a pushing force applied by the caregiver, or sensing a human movement and the like. All these control methods are performed by providing a signal from a sensor on a carriage of the stroller via an external factor, so as to control a power assistance system to operate at different speeds.

Therefore, there is a requirement to improve the power assistance function of the child strollers. For example, it is desired that the power assistance device of a child stroller can adjust the power assistance according to the load carried by the child stroller, and it is also desired that the power assistance device can adjust the power assistance according to the uphill, downhill or other position conditions of the child stroller. For example, it is desired that the power assistance device is more intelligent, so that when the child stroller has different loads or is in different positions, the caregiver can move the child stroller with roughly the same force. It is also desired that the power assistance device can provide an automatic braking function.

### SUMMARY

A power assistance device according to the present disclosure is used for providing power assistance to a carrier to be moved. The power assistance device includes: a pressure sensor for detecting a total weight G of the carrier; a driving device for providing a driving force F_{d} in a traveling direction to the carrier; and a control unit being in signal connection with the pressure sensor and the driving device, receiving the total weight G detected by the pressure sensor, and being capable of sending a signal to the driving device to adjust the driving force F_{d} outputted by the driving device, such that when the total weight G changes, an external force required to drive the carrier in the traveling direction is maintained at a constant preset force Fₚᵣₑ.

The driving force provided by the driving device counteracts an additional resistance caused by the load on the carrier. In this way, no matter the carrier is empty or loaded, the user can push the carrier with approximately the same preset force.

In an embodiment, the preset force Fₚᵣₑ is a threshold force required to move the carrier when the carrier is under no load condition and placed on a horizontal plane, or an optional empirical value.

The preset force is adjustable, and the preset force can be selected according to a use scenario or a user research result, so as to provide a better use experience.

In an embodiment, the power assistance device further includes: a tactile sensor being in signal connection with the control unit for detecting whether or not a user contacts the carrier; a stopping device being in signal connection with the control unit for braking the carrier; and when the tactile sensor detects that the user does not contact the carrier, the control unit controls the driving device to stop outputting the driving force F_{d}, and activates the stopping device to brake the carrier.

By automatically controlling the stopping device, the carrier can be prevented from slipping and causing danger.

In an embodiment, the driving device is disposed on a front wheel and/or a rear wheel of the carrier.

Since the driving device is directly disposed on the front wheel and/or the rear wheel, the transmission system can be eliminated and the total weight of the carrier can be reduced.

In an embodiment, the pressure sensor includes a first pressure sensor for detecting a load F₁ carried by a carriage of the carrier, wherein the carriage is set up in middle of a frame of the carrier to support a seat; the power assistance device further comprises an angle sensor being in signal connection with the control unit for detecting an inclination angle θ of the traveling direction relative to the horizontal plane; and the control unit calculates a resultant force F required to drive the carrier in the traveling direction according to the total weight G and the inclination angle θ, and adjusts the driving force F_{d} of the driving device.

In this embodiment, the driving force outputted by the driving device can be calculated only by measuring the load and the inclination angle, thereby reducing the calculation complexity.

In an embodiment, the driving force F_{d} is calculated by the following formulas:

$${F}_{d} = F - {F}_{pre}$$

$$F = μ G cos θ + G sin θ$$

$$G = {G}_{0} + {F}_{1}$$

where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, G₀ represents a known empty weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill.

The above calculation formulas are applicable to both uphill and downhill situations, and there is no requirement to switch the calculation formula according to the inclination angle.

In an embodiment, the pressure sensor includes a second pressure sensor and a third pressure sensor; the second pressure sensor is disposed between a carriage for supporting a seat of the carrier and the front wheel, so as to detect a second pressure F₂ between the front wheel and the carriage; the third pressure sensor is disposed between the carriage and the rear wheel, so as to detect a third pressure F₃ between the rear wheel and the carriage; and the control unit receives the detected second pressure F₂ and the detected third pressure F₃, calculates an inclination angle θ of the traveling direction of the carrier relative to the horizontal plane according to the second pressure F₂ and the third pressure F₃, and calculates a resultant force F required to drive the carrier in the traveling direction, and adjusts the driving force F_{d} of the driving device in the traveling direction.

In this embodiment, the inclination angle is no longer directly measured, thus avoiding any possible error caused by the inclination measuring device.

In an embodiment, the driving force F_{d} is calculated by the following formulas:

$${F}_{d} = F - {F}_{pre}$$

$$F = μ G cos θ + G sin θ$$

$$θ = arccos [ ( {G}^{2} + {F}_{2}^{2} - {F}_{3}^{2} ) / 2 G \cdot {F}_{2} ] - α$$

$$G = \sqrt{{F}_{2}^{2} + {F}_{3}^{2} + 2 {F}_{2} {F}_{3} cos ( α + β )}$$

where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill, α represents an included angle between a connecting line extending from a center of the front wheel to a center of gravity of the carriage and a vertical direction of the carrier, β represents an included angle between a connecting line extending from a center of the rear wheel to the center of gravity of the carriage and the vertical direction of the carrier.

In the above formulas, the total weight and inclination of the carrier are calculated through the pressure between the carrier and the front/rear wheel, thereby omitting the requirement to measure the inclination.

In an embodiment, the carrier is a child stroller.

The power assistance device of the application can be advantageously applied to various child strollers.

Beneficial effects of the control method of the application can be similar to those of the power assistance device mentioned above, so they will not be redundantly described again.

A control method of a power assistance device for providing power assistance to a carrier to be moved is provided according to the application. The control method includes: detecting a total weight G of the carrier by a pressure sensor; providing a driving force F_{d} to the carrier by a driving device in a traveling direction; and receiving the total weight G detected by the pressure sensor and sending a signal to the driving device through a control unit, so as to adjust the driving force F_{d} outputted by the driving device, such that when the total weight G changes, an external force required to drive the carrier in the traveling direction is maintained at a constant preset force Fₚᵣₑ.

In an embodiment, the preset force Fₚᵣₑ is a threshold force that is required to move the carrier when the carrier is under no load condition and placed on a horizontal plane, or an optional empirical value.

In an embodiment, the method further includes: detecting whether or not the user contacts the carrier by a tactile sensor; braking the carrier by a stopping device; and when the tactile sensor detects that the user does not contact the carrier, the control unit controls the driving device to stop outputting the driving force F_{d}, and activates the stopping device to brake the carrier.

In an embodiment, the driving device is disposed on a front wheel and/or a rear wheel of the carrier.

In an embodiment, the pressure sensor includes a first pressure sensor for detecting a load F₁ carried by a carriage of the carrier, wherein the carriage is set up in middle of a frame of the carrier to support a seat; the power assistance device further includes an angle sensor for detecting an inclination angle θ of the traveling direction relative to the horizontal plane; and the control unit calculates a resultant force F required to the carrier in the traveling direction according to the total weight G and the inclination angle θ, and adjusts the driving force F_{d} of the driving device.

In an embodiment, the driving force F_{d} is calculated by the following formulas:

$${F}_{d} = F - {F}_{pre}$$

$$F = μ G cos θ + G sin θ$$

$$G = {G}_{0} + {F}_{1}$$

where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, G₀ represents a known empty weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill.

In an embodiment, the pressure sensor includes a second pressure sensor and a third pressure sensor; the second pressure sensor is disposed between a carriage for supporting a seat of the carrier and the front wheel, so as to detect a second pressure F₂ between the front wheel and the carriage; the third pressure sensor is disposed between the carriage and the rear wheel, so as to detect a third pressure F₃ between the rear wheels and the carriage; and the control unit receives the detected second pressure F₂ and the detected third pressure F₃, calculates an inclination angle θ of the traveling direction of the carrier relative to the horizontal plane according to the second pressure F₂ and the third pressure F₃, and calculates a resultant force F required to drive the carrier in the traveling direction, and adjusts the driving force F_{d} of the driving device in the traveling direction.

In an embodiment, the driving force F_{d} is calculated by the following formulas:

$${F}_{d} = F - {F}_{pre}$$

$$F = μ G cos θ + G sin θ$$

$$θ = arccos [ ( {G}^{2} + {F}_{2}^{2} - {F}_{3}^{2} ) / 2 G \cdot {F}_{2} ] - α$$

$$G = \sqrt{{F}_{2}^{2} + {F}_{3}^{2} + 2 {F}_{2} {F}_{3} cos ( α + β )}$$

where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill, α represents an included angle between a connecting line extending from a center of the front wheel to a center of gravity of the carriage and a vertical direction of the carrier, β represents an included angle between a connecting line extending from a center of the rear wheel to the center of gravity of the carriage and the vertical direction of the carrier.

### BRIEF DESCRIPTION OF THE DRAWINGS

Embodiments of the application will be described in detail below in combination with the accompanying drawings, in which:

FIGS. 1 to 3 are perspective views of a child stroller according to the prior art at different angles;

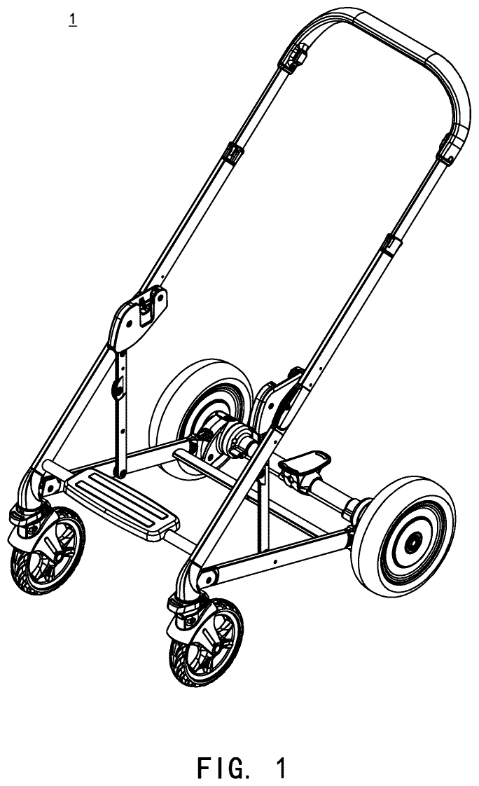

FIG. 4 is a perspective view of a child stroller according to a first embodiment of the present disclosure;

FIG. 5 is a perspective view of a child stroller according to a second embodiment of the present disclosure;

FIG. 6 is an electrical connection diagram of a power assistance device according to the present disclosure;

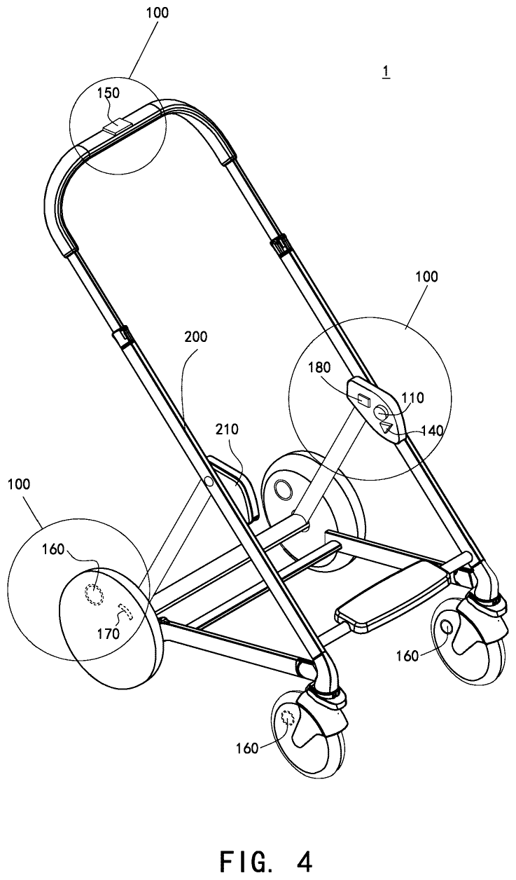

FIG. 7A is a schematic diagram of a force analysis related to gravity about the child stroller when the child stroller is moved on a flat ground;

FIG. 7B is a schematic diagram of a force analysis related to gravity of the child stroller when the child stroller is moved on a slope;

FIG. 8A is a schematic diagram of a force analysis related to forces on front and rear wheels of the child stroller when the child stroller is moved on a flat ground;

FIG. 8B is a schematic diagram of a force analysis related to forces on front and rear wheels of the child stroller when the child stroller is moved on a slope.

### DETAILED DESCRIPTION

Although the invention is illustrated and described herein with reference to specific embodiments, the invention should not be limited to the details shown. Specifically, within the scope of the equivalent solutions of the claims and without departing from the invention, varieties of modifications can be made to these details.

The directional descriptions related herewith, such as “front,” “back,” “up,” and “down” and the like, are only for convenience of understanding, and the invention is not limited to these directions, but can be adjusted according to the actual situation. Moreover, although this present disclosure has been listed and described with reference to typical embodiments, the terms used is illustrative and exemplary, rather than restrictive.

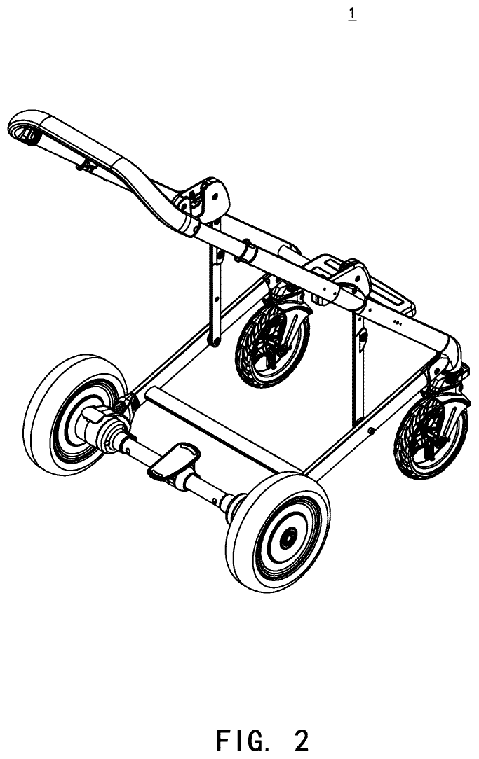

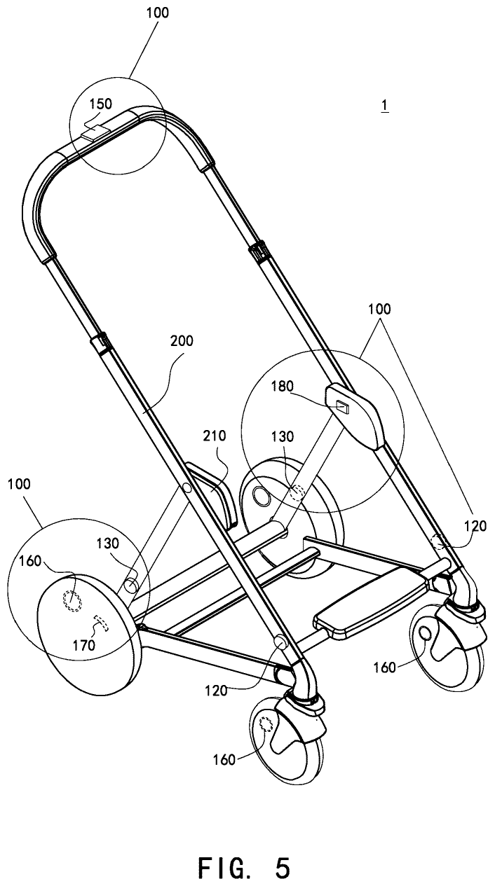

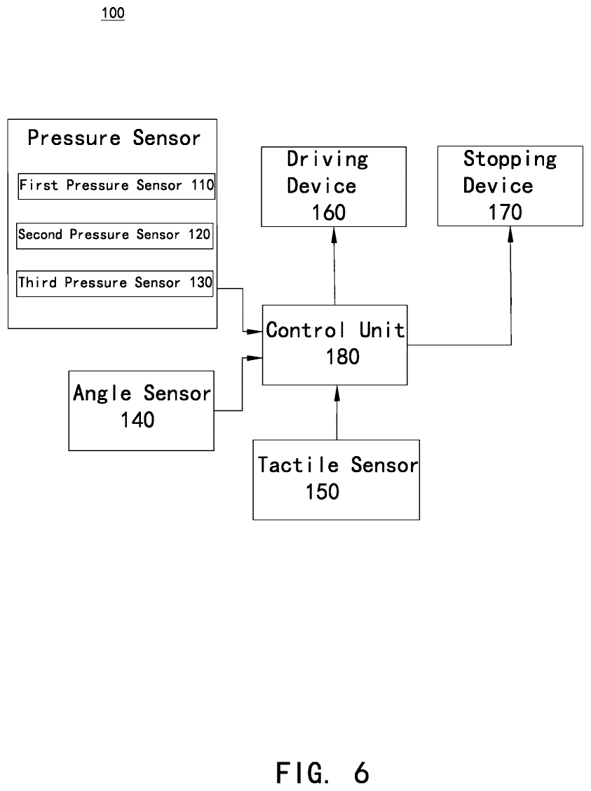

Referring to FIGS. 4 and 7A to 7B, the first embodiment of a child stroller 1 according to the present disclosure is shown. As shown in FIG. 4, the child stroller 1 includes a frame 200 and a power assistance device 100. The power assistance device 100 is used to provide a power assistance to the child stroller 1 to be moved. The power assistance device 100 includes a pressure sensor (that includes a first pressure sensor 110, a second pressure sensor 120, and a third pressure sensor 130), a driving device 160, and a control unit 180. In some embodiments, the power assistance device 100 may further include a tactile sensor 150, and a stopping device 170.

The pressure sensor detects a total weight G of the child stroller 1. The driving device 160 provides a driving force F_{d} to the child stroller 1 in a traveling direction. The control unit 180 is in signal connection with the pressure sensor and the driving device 160 so as to receive the total weight G detected by the pressure sensor, and can send a signal to the driving device 160 to adjust the driving force F_{d} outputted by the driving device 160, such that when the total weight G changes, an external force required to drive the child stroller 1 in the traveling direction is maintained at a constant preset force Fₚᵣₑ.

For sake of clear description, in the present disclosure, a resultant force of all forces driving the child stroller 1 is defined as F, the driving force of the power assistance device 100 is defined as F_{d}, and a driving force provided by the user is defined as Fₚᵣₑ. In this present disclosure, since the driving force provided by the user can be a preset constant force, Fₚᵣₑ represents a preset force. Directions of the resultant force, the driving force, and the preset force are all parallel to the ground. That is, when the child stroller 1 travels uphill or downhill, the inclination angles of the resultant force, the driving force, and the preset force are changed with a slope of the ground. In addition, in formulas in the present disclosure, when values of the resultant force, the driving force, and the preset force are positive (greater than 0), it means that the directions of these forces are the forward direction of the child stroller 1. Moreover, when values of the resultant force F, the driving force F_{d}, and the preset force Fₚᵣₑ are negative (less than 0), it means that the directions of these forces are the reverse direction of the forward direction of the child stroller 1.

In an embodiment, the preset force Fₚᵣₑ is a threshold force that is required to move the child stroller 1 when the child stroller 1 is under no load condition and placed on a horizontal plane. In this case, the calculation formula is Fₚᵣₑ−μ·G₀, where G₀ represents an empty weight of the child stroller 1, and μ represents an empirical resistance constant of the child stroller 1 relative to the ground between a positive pressure and a friction resistance. The positive pressure is a component of the gravity of the child stroller 1 in a direction perpendicular to the ground. When the child stroller 1 is on a horizontal ground, the positive pressure is equal to the gravity. The empirical resistance constant is a sum of all resistances, such as the friction between the wheels of the child stroller 1, the friction of the wheel bearings, and the like.

In other embodiments, the preset force Fₚᵣₑ may be other empirical values, such as a value of moving force that allows the user to operate the child stroller 1 more comfortably according to a user survey.

In an embodiment of the tactile sensor 150 and the stopping device 170, the tactile sensor 150 is in signal connection with the control unit 180, so as to detect whether or not the user touches the child stroller 1. The tactile sensor 150 may be disposed at a position where the user usually contacts the child stroller 1, for example, disposed on a handle. The stopping device 170 may be disposed on one or more wheels, such as the rear wheels. The stopping device 170 is in signal connection with the control unit 180, so as to braking the child stroller 1. Specifically, when the tactile sensor 150 detects that the user does not contact the child stroller 1, the control unit 180 stops the driving device 160 and activates the stopping device 170 to prevent the child stroller 1 from moving.

In this way, when the user does not contact the child stroller 1, the stopping device 170 automatically stops the movement of the child stroller 1, so as to avoid the danger caused by sliding.

In an embodiment, the driving device 160 is disposed on a front wheel and/or a rear wheel of the child stroller 1. The driving device 160 may be an electric hub, an electric motor, a motor, or the like, which provides driving force by converting electric power. A battery (not shown) disposed at a bottom of the frame 200 of the child stroller 1 provides power to the driving device 160. The driving device 160 may be a torque electric motor, which can adjust the outputted torque, so as to adjust the driving force quantitatively. For example, the torque electric motor can adjust the driving force quantitatively according to an inputted current.

In this embodiment, the pressure sensor includes at least one first pressure sensor 110 for detecting a load F₁ carried by at least one carriage 210 of the child stroller 1. The carriage 210 is set up in middle of the frame 200 to support a seat. The total weight of the child stroller 1 is G=G₀+F₁. It should be understood, directions of G, G₀, and F₁ are all vertically downward, and not necessarily perpendicular to the ground.

The power assistance device 100 further includes an angle sensor 140, which is in signal connection with the control unit 180 to detect an inclination angle θ of the traveling direction relative to the horizontal plane. The control unit 180 calculates the resultant force F in the traveling direction required to drive the child stroller 1 according to the total weight G and the inclination angle θ, and adjusts the driving force F_{d} of the driving device 160.

Referring to FIGS. 7A to 7B, in this embodiment, the driving force F_{d} is calculated by the following formulas:

$${F}_{d} = F - {F}_{pre} ;$$

$$F = μ G cos θ + G sin θ ;$$

$$G = {G}_{0} + {F}_{1} ;$$

where θ represents an included angle between the traveling direction and the horizontal plane, and it can be known from the geometric relationship, θ also represents an included angle between the gravity direction and the vertical direction (Z axis) of the child stroller 1. More specifically, when the child stroller 1 travels uphill (FIG. 7B), the gravity direction is in a counterclockwise direction of the vertical direction of the child stroller 1, and θ is a positive value at this time. According to formulas of trigonometric functions, at this time, F is greater than Fₚᵣₑ, and F_{d} is a positive value, which means that the driving force is in the same direction as the forward direction, and the driving device provides a power assistance. When the child stroller 1 travels downhill (not shown), the gravity direction is in a clockwise direction of the vertical direction (Z axis) of the child stroller 1, and θ is negative at this time. According to formulas of trigonometric functions, at this time, F is less than Fₚᵣₑ, and F_{d} is a negative value, which means that the driving force is opposite to the forward direction, and the driving device provides a resistance.

Therefore, when F₁, G₀, Fₚᵣₑ, 0, u are known, F_{d} can be calculated.

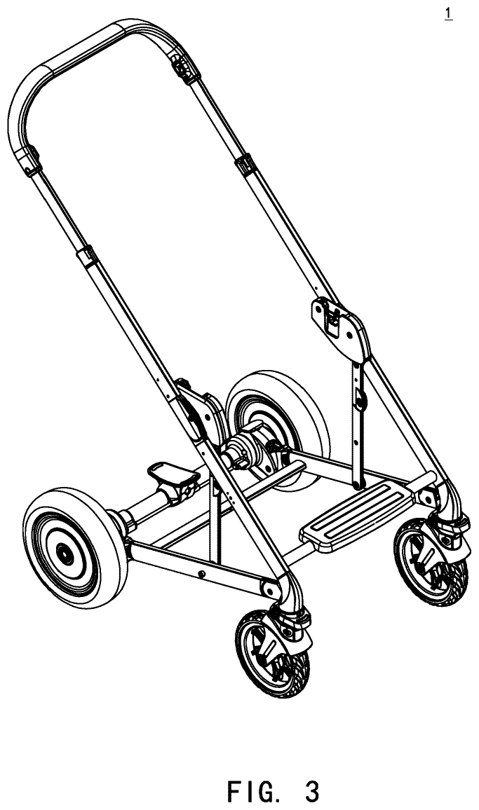

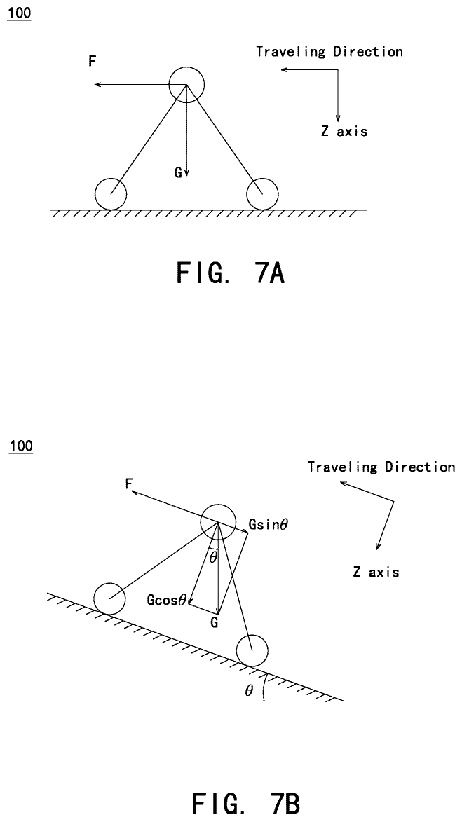

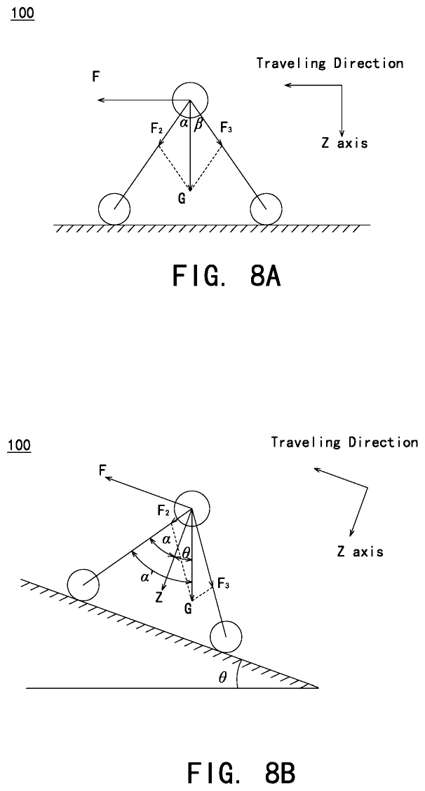

A second embodiment according to the present disclosure will be described with reference to FIGS. 5 and 8A to 8B.

The power assistance device 100 of this embodiment is basically the same as that of the first embodiment, one of differences is that the first pressure sensor 110 and the angle sensor 140 are not provided. Alternatively, the power assistance device 100 of this embodiment is provided with at least one second pressure sensor 120 and at least one third pressure sensor 130.

Specifically, the second pressure sensor 120 is disposed between at least one carriage 210 for supporting the seat and the front wheels of the child stroller 1, so as to detect a second pressure F₂ between the front wheel and the carriage 210. The third pressure sensor 130 is disposed between the carriage 210 and the rear wheel, so as to detect a third pressure F₃ between the rear wheels and the carriage 210. The control unit 180 receives the detected second pressure F₂ and the detected third pressure F₃, calculates the inclination angle θ of the traveling direction of the child stroller 1 relative to the horizontal plane according to the second pressure F₂ and the third pressure F₃, and calculates the resultant force F in the traveling direction required to drive the child stroller 1 to travel, and adjusts the driving force F_{d} of the driving device 160 in the traveling direction.

In this way, in this embodiment, the detected force is the pressure of the carriage 210 applied on the front wheels and the rear wheels.

Referring to FIGS. 8A to 8B, in this embodiment, the driving force F_{d} is calculated by the following formulas:

$${F}_{d} = F - {F}_{pre} ;$$

$$F = μ G cos θ + G sin θ ;$$

$$θ = {α}^{′} - α ;$$

$${α}^{′} = arccos [ ( {G}^{2} + {F}_{2}^{2} - {F}_{3}^{2} \} / 2 G \cdot {F}_{2} ] ;$$

$$G = \sqrt{{F}_{2}^{2} + {F}_{3}^{2} + 2 {F}_{2} {F}_{3} cos ( α + β )} ;$$

where α represents an included angle between a connecting line extending from a center of the front wheel to a center of gravity of the carriage 210 and the vertical direction of the child stroller 1 in the horizontal ground state, β represents an included angle between a connecting line extending from a center of the rear wheel to the center of gravity of the carriage 210 and the vertical direction of the child stroller 1 in the horizontal ground state, α′ represents an included angle between a connecting line extending from the center of the front wheel to the center of gravity of the carriage 210 and the vertical direction of the child stroller 1 in the inclined ground state. In the present disclosure, the vertical direction of the child stroller (vertical direction of the carrier) means a direction perpendicular to the ground, i.e., the Z-axis direction marked in FIGS. 7A to 8B.

It should be understood that, in the above formulas, α and β are determined by the structure of the child stroller 1, regardless of the motion state of the child stroller 1. Accordingly, α and β are known values.

In addition, according to the above formula, it is necessary to calculate G according to a, B, F₂, F₃ when the child stroller 1 is on the horizontal ground. The horizontal state of the stroller can be determined according to a ratio of F₂ and F₃. For example, according to the sine theorem, when F₂/F₃=sin β/sin α, it can be determined that the child stroller 1 is in a horizontal state. The horizontal state of the stroller can also be determined by an additional level gauge or gyroscope (not shown).

The operation of the child stroller 1 according to the present disclosure will be described below.

When the child stroller 1 is on the horizontal ground, and the tactile sensor 150 does not detect the user, the stopping device 170 is activated and the corresponding wheel(s) cannot rotate; moreover, when the tactile sensor 150 detects that the user is holding the child stroller 1, the stopping device 170 is turned off and the corresponding wheel(s) can rotate, while the driving device 160 is activated and provides the driving force F_{d}. In the case that the second pressure sensor 120 and the third pressure sensor 130 are provided, G is calculated by F₂, F₃.

When the child stroller 1 is travelling uphill, an operation method is similar to that of the child stroller 1 on the horizontal ground.

When the child stroller 1 is travelling downhill, the gravity force component is consistent with the traveling direction, and even if no force is applied, a phenomenon of sliding may occur. According to the stopping device 170 provided in this present disclosure, when the tactile sensor 150 does not detect the user, the stopping device 170 is activated and the corresponding wheel(s) cannot rotate. When the tactile sensor 150 detects the user, the stopping device 170 is turned off and the corresponding wheel(s) can rotate, while the driving device 160 is activated and provides the driving force F_{d} in a direction opposite to the traveling direction (in which the driving force F_{d} is shown as a negative value in the above calculation formula). At this time, the user still needs to apply the preset force Fₚᵣₑ, to move the child stroller 1.

In an embodiment, the stopping device 170 can be an electric brake system and the electric brake system can be used in cooperation with a manual brake (not shown). When the power supply for the child stroller 1 is turned off, the brake can be manually controlled.

In conclusion, the present disclosure provides an active power-assisted child stroller, in which an output of the electric drive power is controlled by the control unit. As such, a loaded child stroller is allowed to be moved even though the user applying a force for moving an unloaded child stroller, thereby improving the use experience.

The child stroller of the present disclosure is provided with a tactile sensor, which can sense whether the user is holding the child stroller by hand. Therefore, the power assistance is only activated when the user uses the child stroller, and the child stroller is locked when the user does not use the child stroller to prevent it from slipping.

In the control method of the child stroller according to the present disclosure, control is performed by automatically sensing the gravity, which is more stable and effective than manual control, thus avoiding misoperation caused by human error.

The present disclosure provides a power assistance device and its control method based on a child stroller. However, it should be understood that the power assistance device and its control method according to the present disclosure can also be applied to other carriers.

Since this present disclosure can be embodied in various forms without departing from the spirit and essence of the present disclosure, it should be understood, the above-mentioned embodiments are not limited to any of the foregoing details, but should be interpreted in the broadest sense within the scope defined by the claims. Therefore, all changes that fall within the scope of the claims or their equivalents should be covered by the claims.

### LIST OF REFERENCE SIGNS

1: Child Stroller
100: Power Assistance Device
   110: First Pressure Sensor (Total Weight Sensor)
   120: Second Pressure Sensor (Front Wheel Sensor)
   130: Third Pressure Sensor (Rear Wheel Sensor)
   140: Angle Sensor
   150: Tactile Sensor
   160: Driving Device
   170: Stopping device
   180: Control Unit
200: Frame
   210: Carriage
Z: Vertical Axis
F_{d}: Driving Force
F: Resultant Force
Fₚᵣₑ: Preset Force (Driving Force Provided By User)
G: Total Weight
G₀: Empty Weight
F₁: First Pressure (Load)
F₂: Second Pressure
F₃: Third Pressure
μ: Empirical Resistance Constant
θ: Inclination Angle
α: First Included Angle (An Included Angle Between Line Connecting Centre Of Front Wheel And Carriage And Vertical direction Of Child Stroller)
β: Second Included Angle (An Included Angle Between Line Connecting Centre Of Rear Wheel And Carriage And Vertical direction Of Child Stroller)

1. A power assistance device for providing power assistance to a carrier to be moved, wherein the power assistance device comprises:
a pressure sensor for detecting a total weight G of the carrier;
a driving device for providing a driving force F_{d} in a traveling direction to the carrier;
a control unit being in signal connection with the pressure sensor and the driving device, receiving the total weight G detected by the pressure sensor, and being capable of sending a signal to the driving device to adjust the driving force F_{d} outputted by the driving device, such that when the total weight G changes, an external force required to drive the carrier in the traveling direction is maintained at a constant preset force Fₚᵣₑ.

2. The power assistance device according to claim 1, wherein:
the preset force Fₚᵣₑ is a threshold force required to move the carrier when the carrier is under no load condition and placed on a horizontal plane, or an optional empirical value.

3. The power assistance device according to claim 1, wherein the power assistance device further comprises:
a tactile sensor being in signal connection with the control unit for detecting whether or not a user contacts the carrier;
a stopping device being in signal connection with the control unit for braking the carrier; and
when the tactile sensor detects that the user does not contact the carrier, the control unit controls the driving device to stop outputting the driving force F_{d}, and activates the stopping device to brake the carrier.

4. The power assistance device according to claim 1, wherein:
the driving device is disposed on a front wheel and/or a rear wheel of the carrier.

5. The power assistance device according to claim 4, wherein:
the pressure sensor includes a first pressure sensor for detecting a load F₁ carried by a carriage of the carrier, wherein the carriage is set up in middle of a frame of the carrier to support a seat;
the power assistance device further comprises an angle sensor being in signal connection with the control unit for detecting an inclination angle θ of the traveling direction relative to the horizontal plane; and
the control unit calculates a resultant force F required to drive the carrier in the traveling direction according to the total weight G and the inclination angle θ, and adjusts the driving force F_{d} of the driving device.

6. The power assistance device according to claim 5, wherein:
the driving force F_{d} is calculated by the following formulas:
$${F}_{d} = F - {F}_{pre}$$
$$F = μ G cos θ + G sin θ$$
$$G = {G}_{0} + {F}_{1}$$
where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, G₀ represents a known empty weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill.

7. The power assistance device according to claim 4, wherein:
the pressure sensor includes a second pressure sensor and a third pressure sensor;
the second pressure sensor is disposed between a carriage for supporting a seat of the carrier and the front wheel, so as to detect a second pressure F₂ between the front wheel and the carriage;
the third pressure sensor is disposed between the carriage and the rear wheel, so as to detect a third pressure F₃ between the rear wheel and the carriage; and
the control unit receives the detected second pressure F₂ and the detected third pressure F₃, calculates an inclination angle θ of the traveling direction of the carrier relative to the horizontal plane according to the second pressure F₂ and the third pressure F₃ and a resultant force F required to drive the carrier in the traveling direction, and adjusts the driving force F_{d} of the driving device in the traveling direction.

8. The power assistance device according to claim 7, wherein:
the driving force F_{d} is calculated by the following formulas:
$${F}_{d} = F - {F}_{pre}$$
$$F = μ G cos θ + G sin θ$$
$$θ = arccos [ ( {G}^{2} + {F}_{2}^{2} - {F}_{3}^{2} ) / 2 G \cdot {F}_{2} ] - α$$
$$G = \sqrt{{F}_{2}^{2} + {F}_{3}^{2} + 2 {F}_{2} {F}_{3} cos ( α + β )}$$
where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill, α represents an included angle between a connecting line extending from a center of the front wheel to a center of gravity of the carriage and a vertical direction of the carrier, ß represents an included angle between a connecting line extending from a center of the rear wheel to the center of gravity of the carriage and the vertical direction of the carrier.

9. The power assistance device according to claim 1, wherein:
the carrier is a child stroller.

10. A control method of a power assistance device for providing power assistance to a carrier to be moved, wherein the control method comprises:
detecting a total weight G of the carrier by a pressure sensor;
providing a driving force F_{d} to the carrier by a driving device in a traveling direction; and
receiving the total weight G detected by the pressure sensor and sending a signal to the driving device through a control unit, so as to adjust the driving force F_{d} outputted by the driving device, such that when the total weight G changes, an external force required to drive the carrier in the traveling direction is maintained at a constant preset force Fₚᵣₑ.

11. The control method according to claim 10, wherein:
the preset force Fₚᵣₑ is a threshold force that is required to move the carrier when the carrier is under no load condition and placed on a horizontal plane, or an optional empirical value.

12. The control method according to claim 10, wherein the method further comprises:
detecting whether or not the user contacts the carrier by a tactile sensor;
braking the carrier by a stopping device; and
when the tactile sensor detects that the user does not contact the carrier, the control unit controls the driving device to stop outputting the driving force F_{d}, and activates the stopping device to brake the carrier.

13. The control method according to claim 10, wherein:
the driving device is disposed on a front wheel and/or a rear wheel of the carrier.

14. The control method according to claim 13, wherein:
the pressure sensor includes a first pressure sensor for detecting a load F₁ carried by a carriage of the carrier, wherein the carriage is set up in middle of a frame of the carrier to support a seat;
the power assistance device further includes an angle sensor for detecting an inclination angle θ of the traveling direction relative to the horizontal plane; and
the control unit calculates a resultant force F required to the carrier in the traveling direction according to the total weight G and the inclination angle θ, and adjusts the driving force F_{d} of the driving device.

15. The control method according to claim 14, wherein:
the driving force F_{d} is calculated by the following formulas:
$${F}_{d} = F - {F}_{pre}$$
$$F = μ G cos θ + G sin θ$$
$$G = {G}_{0} + {F}_{1}$$
where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, G₀ represents a known empty weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill.

16. The control method according to claim 13, wherein:
the pressure sensor includes a second pressure sensor and a third pressure sensor;
the second pressure sensor is disposed between a carriage for supporting a seat of the carrier and the front wheel, so as to detect a second pressure F₂ between the front wheel and the carriage;
the third pressure sensor is disposed between the carriage and the rear wheel, so as to detect a third pressure F₃ between the rear wheels and the carriage; and
the control unit receives the detected second pressure F₂ and the detected third pressure F₃, calculates an inclination angle θ of the traveling direction of the carrier relative to the horizontal plane according to the second pressure F₂ and the third pressure F₃, and calculates a resultant force F required to drive the carrier in the traveling direction, and adjusts the driving force F_{d} of the driving device in the traveling direction.

17. The control method according to claim 16, wherein:
the driving force F_{d} is calculated by the following formulas:
$${F}_{d} = F - {F}_{pre}$$
$$F = μ G cos θ + G sin θ$$
$$θ = arccos [ ( {G}^{2} + {F}_{2}^{2} - {F}_{3}^{2} ) / 2 G \cdot {F}_{2} ] - α$$
$$G = \sqrt{{F}_{2}^{2} + {F}_{3}^{2} + 2 {F}_{2} {F}_{3} cos ( α + β )}$$
where F_{d} represents the driving force of the driving device in the traveling direction, F represents the resultant force required to drive the carrier in the traveling direction, Fₚᵣₑ represents the preset force required to drive the carrier in the traveling direction, G represents the total weight of the carrier, μ represents an empirical resistance constant of the carrier between a positive pressure and a friction resistance relative to a ground, θ represents an included angle between the traveling direction and the horizontal plane, and θ is positive when the carrier travels uphill and is negative when the carrier travels downhill, α represents an included angle between a connecting line extending from a center of the front wheel to a center of gravity of the carriage and a vertical direction of the carrier, ß represents an included angle between a connecting line extending from a center of the rear wheel to the center of gravity of the carriage and the vertical direction of the carrier.
